(19) United States
(12) Patent Application Publication
(10) Pub. No.: US 2014/0342327 A1
(43) Pub. Date: Nov. 20, 2014

(54) Removing learning effect from cognitive tests

(71) Applicant: Sync-Think, Inc., Boston, MA (US)

(72) Inventor: Matthew E. Stack, Pittsfield, MA (US)

(73) Assignee: Sync-Think, Inc., Boston, MA (US)

(21) Appl. No.: 13/986,603

(22) Filed: May 16, 2013

(51) Int. Cl. G09B 23/28

(52) U.S. Cl. CPC G09B 23/28
USPC 434/236

(57) ABSTRACT

A system for removing the learning effects from cognitive tests includes variation of the difficulty of the test between the administering of the tests so as to minimize the ability of a test taker to memorize a test.

### FIELD OF THE INVENTION

This invention relates to cognitive performance testing and more particularly a system and method for removing learning effects from cognitive tests.

### BACKGROUND OF THE INVENTION

Smooth pursuit eye movement has been demonstrated to be a reliable and robust mechanism of cognitive testing to evaluate a variety of cognitive, brain, and disease states. It has been proven to be a reliable quantitative indicator of both cognitive improvement and deterioration. Consequently, eye movement analysis, especially relating to smooth pursuit, has grown in application throughout various markets such as the elite military forces, high performance athletics, and pharmaceutical clinical research environments.

As shown in U.S. patent application Ser. No. 13/815,571 filed Mar. 11, 2013; Ser. No. 13/694,461 filed Dec. 4, 2012; Ser. No. 13/507,991 filed Aug. 10, 2012; Ser. No. 13/694,873 filed Jan. 14, 2013; and Ser. No. 13/694,462 filed Dec. 4, 2012 all incorporated herein by reference, a variety of eye tracking tests have been developed in the past 10 years in order to vary the desired cognitive effect to be measured. The development of such eye tracking tests mostly involved implementing a variety of paths or changing the velocities or angles of movement. This has seen varying levels of success. Some tests have been more successful than others in measuring cognitive performance and demonstrating that degrees of variation in the path or nature of the test have specific isolated functional or topological correlates within the brain.

Although the baseline data for the cognitive test is still essentially the eye position of the test taker, and the target position of the dot or icon they are trying to follow, it has been shown in principle that varying the attributes of the test can measure different cognitive functions and assess different isolated parts of the brain.

Currently, there has been an expansion in the number of cognitive tests that rely on the eye as the sole source of incoming data. Some tests are beginning to contemplate the combination of eye track-based data with the combination of other cognitive testing modalities. However, as of now, only a few have demonstrated a level of diagnostic power above and beyond the basic eye tracking test modality. As eye tracking based cognitive testing continues to increase in popularity, its strengths and weaknesses are better understood. Specifically, in the domain of smooth pursuit eye movement tracking tests, limitations are better understood as tests are being applied to broader applications in the pharmaceutical industry, and in the medical diagnostic industries.

Smooth pursuit tests have been demonstrated to be widely applicable to a number of cognitive evaluation contexts where the eyes are used as a proxy to the brain states exhibited by the patient. However, smooth pursuit eye tests have also been used in a number of cases in which the stability, repeatability, reliability or statistical relevance of the analytical measures of the eye performance are used to assess cognitive performance extremes, meaning high or low cognitive performance. Such smooth pursuit movement tests are then applied to patients over time, taken once every few weeks or months, and the resulting scores are analyzed to determine trends and changes of their cognitive performance over time.

During each test session, the smooth pursuit eye movement tests are administered multiple times back to back within a short time frame in order to reduce and account for environmental or calibration errors for a more accurate score to reflect the patient's cognitive performance. However, in multiple testing, a number of phenomena have been observed that are generally regarded as negative features of smooth pursuit eye movement. It is important to eliminate these effects of multiple testing as they introduce sources of unpredictability and error in the data.

The most obvious of these limitations is known as the “learning effect” insofar as smooth pursuit is applied in short time frames or repeated. As a result of the repeated testing, the test scores are seen to improve because the patient gets more adept at taking the test, and can function well at a rate faster than could be attributed to any expected neural, biological, or structural explanation.

The learning effect specifically refers to the process by which the same patient is seen to improve in the quantitative score result of the test at a rate faster than what could normally be attributed to biological change in the brain or neuroplasticity.

For instance, a patient may take a test and score a 3.0 out of 10, where a lower score is regarded as higher cognitive performance. That same patient may take the test again after 10 minutes and score a 2.5 out of 10. If the patient waits another 3 hours before taking the test again, the score is now seen to depress back to 3.0 out of 10. However, if the patient takes the test again after 10 minutes, the score may be seen to improve again to 2.5 out of 10. This repeatable improvement within a short time frame in the absence of long term improvement suggests that the patient learned to perform better on the test as a result of a brief training period in which the first test taking served as a “training test” and the second test benefited from the improvement as a result of the training.

The learning effect is not always observed in patients. Regardless of the level of the patient's cognitive state; advanced, normal or impaired, some patients show no signs of the learning effect. It seems, therefore, that the learning effect is unique to some patients, although it is not expected to be a form of expressed neuroplasticity in the sense that a structural biological change in the topology or architecture of neurons is thought to have taken place. Instead, it would appear that some patients have a different precondition to improve in the smooth pursuit paradigm, perhaps as a result of the presence of absence of prior stimulation or training that can be thought to be related to smooth pursuit. For instance, in some athletes whose sports rely on the continuous tracking of one or more balls during gameplay, the learning effect is more difficult to observe. In contrast, patients who generally have sedate or inactive lifestyles and have no athletic or videogame history, tend to demonstrate the learning effect more dramatically or more frequently.

There are criticisms and detractors to the learning effect, who discount it as a phenomenon seen across all neuro-cognitive and psychological testing. However, if a cognitive testing modality is to be reliable enough to produce accurate and consistent measurements of human cognitive ability, especially in a modality linked to determining the efficacy of neuro-pharmaceutical compounds or determining a patient's cognitive disease state or recovery state, then ideally the test should not exhibit significant perturbations of the test score result, such as the learning effect.

### SUMMARY OF THE INVENTION

This invention contemplates methods to which eye tracking based tests, especially those based and linked to the smooth pursuit eye movement paradigm, no longer have the learning effect present in any period time, whether short term or long term that is not otherwise associated with fundamental cognitive changes of a neurobiological, functional or architectural nature of the brain.

Specifically, the invention is a design for a smooth pursuit path that varies in a way that it is not easy to memorize or learn in the basic sense that the path is too complex to be committed to memory easily. Without any assumptions that the learning effect relies on short term or long term memory, it is simply posited that the complexity of a test must be increased in such a way as to make it hard enough for the patient to follow the target during the test such that the patient does not exhibit the learning effect, but not so hard that it changes the outcome of the test. For instance, it is not useful to design a test with a path that is excessively complex, thus rendering the test too difficult to track even for normal or elite patients. This means that movement in unpredictable, short, sharp turning radii are to be avoided, as they are too complex for patients to follow. It is not the objective of this patent, as those paths will also affect and change the outcome score measured by the test.

One design is a smooth pursuit path of a rotating curvilinear shape, which is a shape with smooth edges. In other words, the target, such as a dot or an icon, would continuously move in a fashion of a curvilinear shape as the shape itself is rotating about a given point.

In one version of this test design, a figure eight pattern or an infinity sign pattern is the basic path, which means a target, for instance a dot, moves along the figure eight pattern. However, the figure eight or the infinity sign pattern gradually rotates about its center, so that the figure eight is never in the same orientation in consecutive cycles or iterations. The result is a test that is essentially no harder to perform than the standard circle based smooth pursuit test, except with the addition that it is also devoid of learning effects.

Another design is a smooth pursuit path that alternates the directionality of the target movement spontaneously. For example, the standard circular smooth pursuit test would be altered to spontaneously change the circular target rotation from a clockwise to a counter-clockwise direction and vice versa. This alteration in the standard circular smooth pursuit test design makes the test unpredictable and thus no longer susceptible to the learning effect, while maintaining similar difficulty of a smooth pursuit test.

This invention produces a smooth pursuit eye movement test that is designed to be of similar difficulty to the circular smooth pursuit test, except with the improvement of not exhibiting the learning effect that negatively affects the circular smooth pursuit test due to the predictable circular path. This results in a smooth pursuit eye movement test that exhibits all of the benefits and features of the circular smooth pursuit test, with the additional benefit of higher analytical reliability and greater confidence in the outcome data.

Furthermore, higher quantitative confidence can be achieved in the analytical output from the smooth pursuit testing paradigm in shorter time frames, due to the elimination of the short time frame learning effect. This means that the modality of cognitive testing may now be applied to measuring cognitive improvements in a much shorter time frame. For instance, whereas previous minimum measurements required assessment of no shorter than 3 days between tests, the subject invention allows one to analyze patients back to back within minutes.

Shorter time horizons are also required for the assessment of neuro-pharmaceutical products in order to measure efficacy. This invention allows researchers and neuro-pharmaceutical product developers to mine effective compounds for their potential to improve cognitive performance in much shorter time frames. Instead of being forced to wait days to determine the efficacy or outcome of positive or negative effect of a drug, that same information can be determined within minutes or at the longest, within hours.

### BRIEF DESCRIPTION OF THE DRAWINGS

These and other features of the subject invention are better understood in connection with the detailed description in conjunction with drawings of which:

FIG. 1 is a diagrammatic illustration of the variation of smooth pursuit path complexity to prevent memorization and thus to remove learning effects from the cognitive function measurement;

FIG. 2 is a diagrammatic illustration of the types of cognitive function detection apparatus that may be used in connection with cognitive function detection; and,

FIG. 3 is a flow chart showing one algorithm for measuring cognitive function using the desktop system.

### DETAILED DESCRIPTION

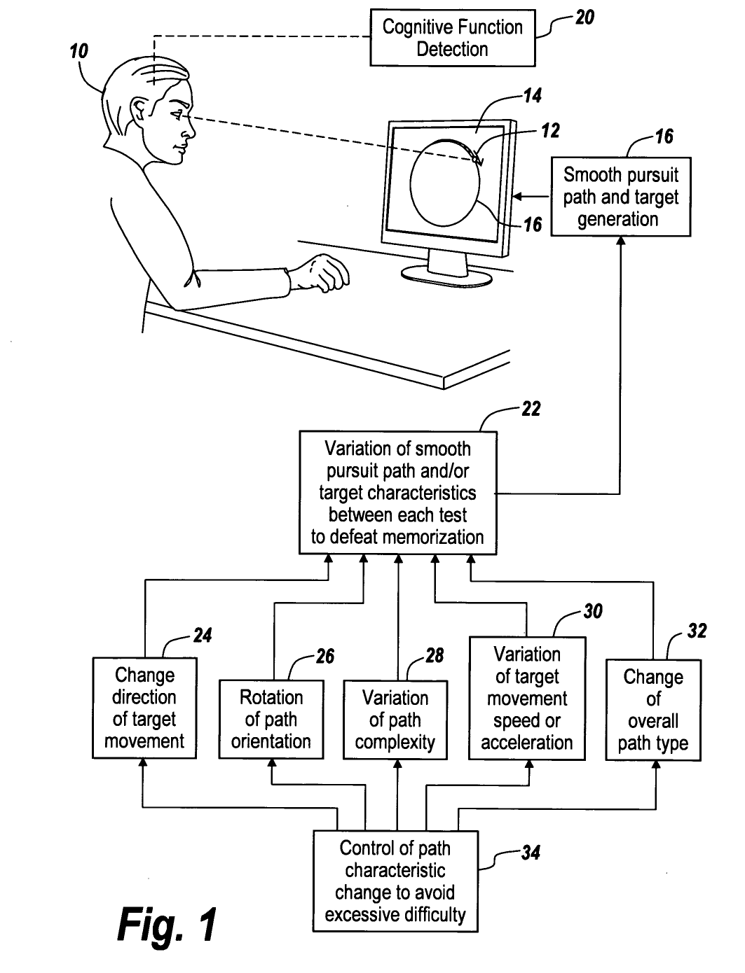

Referring now to FIG. 1, a patient or test subject 10 is directed to track an icon or target 12 on a screen 14 as it executes a path 16 shown in this case to be circular. This particular path configuration generated by a smooth path and target generation module 16 which generates the on-screen target and cause it to travel along a predetermined path.

While the subject invention will be discussed in terms of a circular path, various other path types are within the scope of this invention. For instance, the curve could be a continuous but loped path or could for instance involve a FIG. 8 or lissajou figure as well as for instance being a path of some different order of complexity.

It is the purpose of the subject invention as shown at 20 to eliminate from the cognitive function detection any effects of memorization of the target motion.

In order to eliminate or at least minimize the learning effect associated with memorization, in one embodiment as shown at 22 smooth pursuit path and target generation is altered by varying the smooth pursuit and/or target characteristics between each test to defeat memorization.

As shown at 24 one change, which would not materially affect the difficulty of the test, is to change the direction of target movement. As shown at 26 one could also rotate the path orientation, which would be more visible in a non-circular smooth pursuit path. Thus, for instance, if the path were oblong or for instance multi-lobed, simply rotating the path orientation could be enough to eliminate learning effects due to memorization of the target path. As shown at 28 one can also vary the path complexity meaning for instance that if one goes from a circle to for instance two lobes, one can vary the path of the target presented to the patient so that the patient would have difficulty in memorizing between the tests. As shown at 30 one can also vary the speed or acceleration of the target itself, whereas as shown at 32 one can change the overall path type for instance from one that is circular to one that is an ellipse or one that for instance is multi-lobed or of a FIG. 8 or lissajou type.

All of the above variations are under the control of a module 34, which controls the path characteristic change to avoid excessive difficulty. As noted above, in order to obtain consistency of measured cognitive performance it is important that whatever test is administered in successive time periods has approximately the same type of difficulty. Thus, for instance, excessive difficulty could cause the cognitive performance data to be skewed if for instance the change in the smooth pursuit path were such as to be too difficult for the patient to follow or would engender a different level of test difficulty.

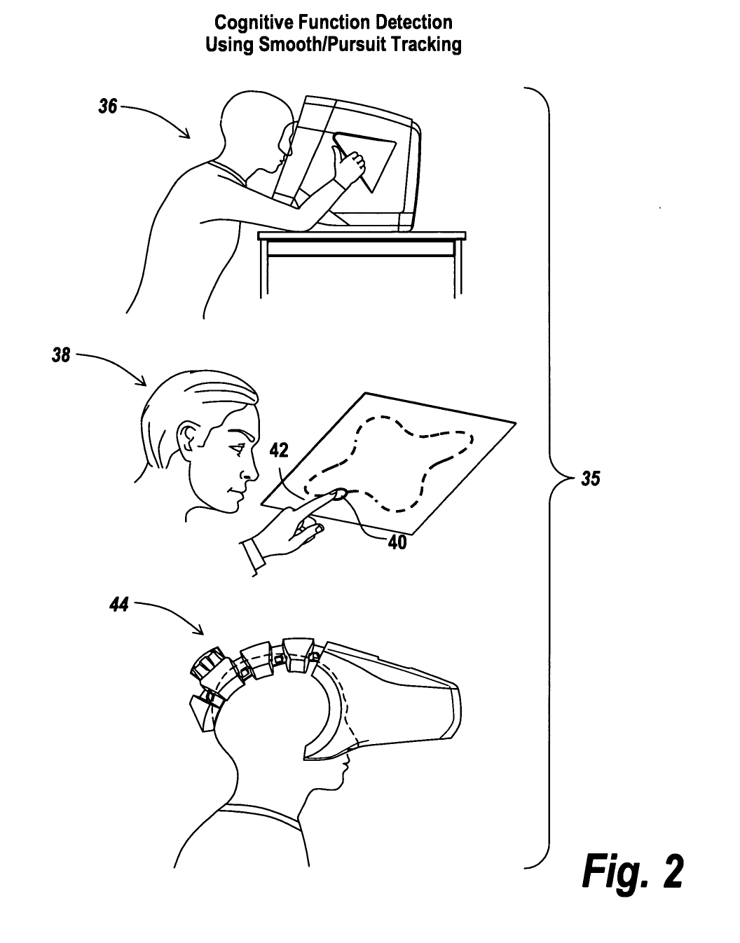

Referring now to FIG. 2, while it will be seen as illustrated at 35 that any cognitive function detection device or mechanism may be utilized to monitor cognitive function, as shown at 36 one may measure cognitive function through eye tracking utilizing a desktop version of an eye tracker such as described in U.S. patent application Ser. No. 13/507,991 filed Aug. 10, 2012 and incorporated herein by reference. As illustrated at 38 the cognitive function detection unit may be a tablet as illustrated in U.S. patent application Ser. No. 12/931,881 filed Feb. 12, 2011 which presents a moving target 40 with the position of the target being indicated by the person's finger 42 or otherwise. Finally, as shown at 44 a helmet mounted eye tracking system such as illustrated in U.S. patent application Ser. No. 13/506,870 filed Mar. 11, 2012 and incorporated herein by reference can be utilized in which the helmet mounted system tends to eliminate environmental factors such as light and noise.

Regardless of the cognitive function detection mechanism or unit, it is important to be able to eliminate the reading effect and in order to do so it is important to be able to move a target on a path in a different manner so that its motion is not easily mesmerized from one test to the other.

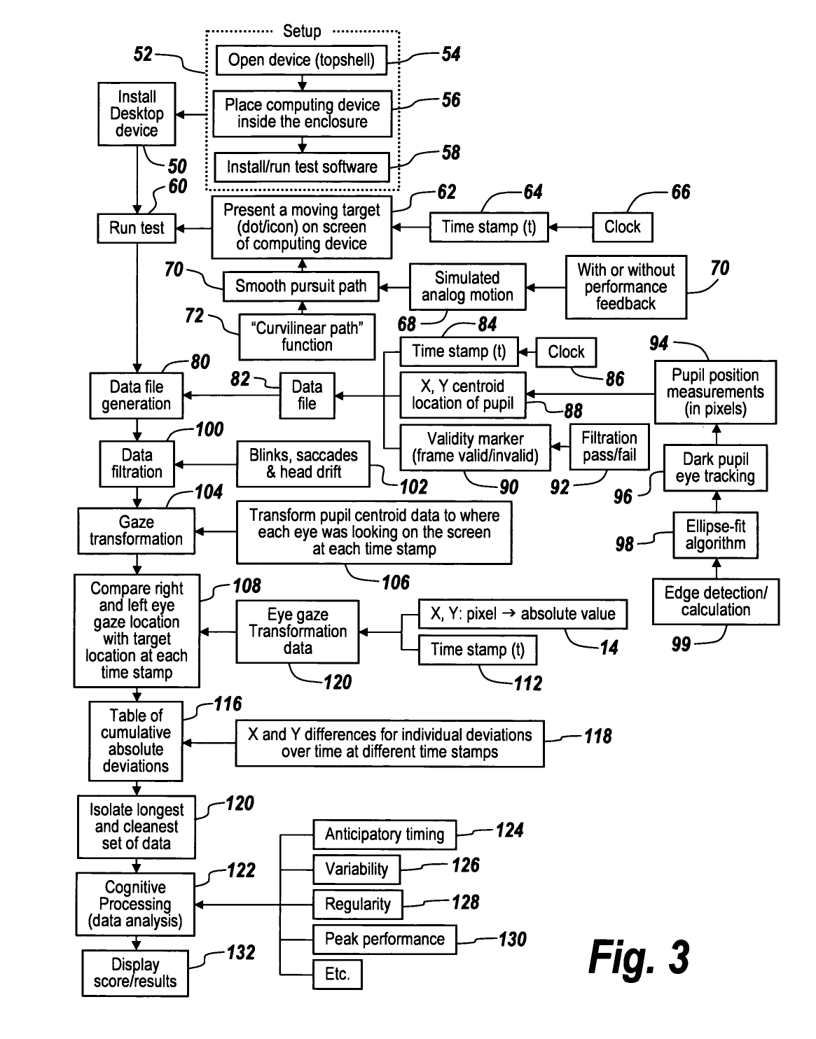

Referring now to FIG. 3, in one embodiment for the precision measurement of cognitive awareness, as seen at 50 one initially installs a desktop device and sets it up as illustrated at 52 first by opening the top shell of the device is illustrated at 54 and by placing the computing device inside the disclosure as illustrated at 56, whereupon one installs and runs tests software as illustrated at 58. Thereafter a test is run as illustrated at 60 by presenting a moving target which is a dot or icon 62 on a screen of the computing device. This moving target is time stamped at 64 utilizing a clock 66 with simulated analog motion 68 used to generate a smooth pursuit path 70 that is utilized to drive the motion of the icon on the screen. The smooth pursuit path is in one embodiment a curvilinear path 72. Note clock 66 coupled to the simulated analog motion unit 68 as illustrated at 74 with or without a performance feedback.

When the test is run, a data file is generated at 80 from a data file 82 that is in turn time stamped at 84 utilizing a clock 86. Data file 82 stores the X,Y location of the centroid location of the pupil 88. Also stored is a validity marker 90 that a frame is valid or invalid derived from the output of pass/fail and filtration operation 92. The pupil position measurements as illustrated at 94 utilized to derive the X,Y centroid of location of the pupil. These pupil position measurements use pupil eye tracking 96 which incorporates an ellipse-fit algorithm 98 and edge detection calculations 90, thus to accurately determine gaze direction through the X,Y centroid location of the pupil. Having the generated data file 80, one utilizes a data filtration step 100 that eliminates blinks, saccades and head drift as illustrated 102.

Having filtered the data, the next step is gaze transformation 104 in which as illustrated at 106, one transforms pupil centroid data to where each eye is looking on the screen at each time stamp. Gaze direction is ascertained in the traditional manner as described above.

After having transformed the gaze to provide a gaze direction as illustrated, at 108 one compares the left eye and the right eye gaze location with target location at each time stamp. Eye gaze transformation data is available for this process at 110 having been time stamped at 112 and having been derived from an X, Y pixel location transformed into absolute values at 114.

Thereafter a table of cumulative absolute deviations is derived at 116 utilizing X and Y differences for individual deviations over time at different time stamps as illustrated at 118.

Then, the longest and cleanest set of data is isolated at 120 and cognitive processing, namely data analysis, is performed at 122. The cognitive processing includes metrics such as ascertaining anticipatory timing 124, variability 126, regularity 128 and peak performance 130, after which, depending on the metric utilized, the results are displayed at 132 either as a score or some other result representation.

The above processing provides an inordinate amount of processing to filter out outlying data, blinks, saccades, head drift and other environmental factors, such that when gaze direction is calculated all the extraneous effects of noise are eliminated from the gaze direction data. Environmental and head position noise has already been limited by the use of the subject desktop device to eliminate ambient light from getting into the system and to minimize the effect of head movement since the head is clamped to the mask on the desktop device.

What has therefore been described is a desktop system for cognitive performance, which is portable and is exceptionally inexpensive and yet provides sufficient accuracy and precision to be useful in clinical drug analysis.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A system for removing learning effects from repeated cognitive tests, comprising:
a unit for administering a cognitive test in which an opto-cognitive test modality is employed and,
varying the test administered to a test taking individual between tests so as to prevent the individual from memorizing the test.

2. The system of claim 1, wherein said opto-cognitive test modality includes a smooth pursuit test.

3. The system of claim 2, wherein said smooth pursuit test includes presenting an on-screen target having at least one target characteristic and moving said target along a smooth pursuit path.

4. The system of claim 3, wherein the variation of said cognitive test includes variation of said smooth pursuit path.

5. The system of claim 3, wherein the variation of said cognitive test includes variation of target characteristics.

6. The system of claim 3, wherein the variation of said smooth pursuit path or said target characteristic between each test includes control of said path and said target characteristic to avoid excessive difficulty.

7. The system of claim 2, wherein the said smooth pursuit test includes an on-screen target having a predetermined characteristic traveling along a smooth pursuit path and wherein variation of said test includes variation of said smooth pursuit path or target characteristic that duplicates the difficulty of the test prior to variation.

8. The system of claim 7, wherein said test variation includes change of direction of target movement.

9. The system of claim 7, wherein test variation includes rotation of path orientation.

10. The system of claim 7, wherein said test variation includes variation of path complexity.

11. The system of claim 7, wherein said test variation includes variation of target movement including one of speed and acceleration.

12. The system of claim 7, wherein said test variation includes change of overall path type.

13. The system of claim 7, wherein the metric measured by said smooth pursuit test includes one of anticipatory timing, variability, regularity and peak performance.

14. A method for removing learning effects from repeated cognitive tests, comprising the step of varying the test administered to a test taking individual between tests so as to prevent the individual from memorizing the test.

15. The method of claim 14, wherein the cognitive tests include an opto-cognitive test.

16. The method of claim 15, wherein the opto-cognitive test includes a smooth pursuit test.

17. The method of claim 16, wherein the smooth pursuit test includes presenting an on-screen target having at least one target characteristic and moving the target along a smooth pursuit path.

18. The method of claim 17, wherein the variation of the smooth pursuit test includes variation of the smooth path.

19. The method of claim 17, wherein variation of the smooth pursuit test includes variation of target characteristics.

20. The method of claim 17, wherein the smooth pursuit test variation test includes control of the path and the target characteristics to avoid excessive difficulty.

21. The method of claim 17, wherein the smooth pursuit test variation includes change of direction of target movement.

22. The method of claim 17, wherein the smooth pursuit test variation includes rotation of path orientation.

23. The method of claim 17, wherein the smooth pursuit test variation includes variation of path complexity.

24. The method of claim 17, wherein the metric utilized for measuring cognitive performance in the smooth pursuit test includes one of anticipatory timing, variability, regularity and peak performance.

25. Apparatus for removing learning effects from repeated cognitive tests comprising:
an opto-cognitive test unit in which the test administered to a test taking individual is varied between tests so as to prevent the individual from memorizing the test.

26. The system of claim 25, wherein said octo-cognitive test unit includes a screen for presenting a target moving along a smooth pursuit path.

27. The system of claim 26, wherein said screen is part of a tablet.

28. The system of claim 26, wherein said screen is carried in a desktop unit.

29. The system of claim 26, wherein said screen is carried by a helmet worn by the test taking individual.
